(19) United States
(12) Patent Application Publication
(10) Pub. No.: US 2026/0197326 A1
(43) Pub. Date: Jul. 9, 2026

(54) ROBUST VEHICLE METRICS UNDER VEHICLE SPOOFING CONDITIONS

(71) Applicant: Ford Global Technologies, LLC, Dearborn, MI (US)

(72) Inventors: David Michael Herman, West Bloomfield, MI (US); Anuj Pal, St Paul, MN (US); Colleen Hummel, Northville, MI (US)

(21) Appl. No.: 19/015,031

(22) Filed: Jan. 9, 2025

(51) Int. Cl. H04L 9/40

(52) U.S. Cl. CPC H04L 63/1416; H04L 63/123

(57) ABSTRACT

Detecting and addressing data spoofing in vehicle signal analysis is provided. A plurality of trust scores are calculated for a plurality of vehicle signals. Each of the trust scores measures a likelihood that a respective one of the plurality of vehicle signals is authentic and not spoofed. Aggregate trust scores are calculated for aggregate signals using the trust scores of the vehicle signals contributing to the aggregate signals, wherein the aggregate signals are created via a transformation performed using one or more of the plurality of the vehicle signals over time. It is determined whether the trust scores and/or the aggregate trust scores meet a predefined threshold. The vehicle signals and/or the aggregate signals are applied to an analysis model to determine metrics based on the trust scores and/or aggregate trust scores meeting a predefined minimum trust threshold.

### TECHNICAL FIELD

Aspects of the disclosure generally relate to detecting and addressing various types of data spoofing of vehicle data used in the determination of metrics from the vehicle data.

### BACKGROUND

Connected vehicles may send data to a cloud system. Usage-based insurance (UBI) is a type of vehicle insurance whereby the premium cost is dependent on the driving behavior of a driver. A UBI device may be connected to a vehicle network via a connector such as an on-board diagnostic II (OBD-II) port to collect vehicle operating data and send the data to a remote server for analysis. In other examples, a telematics control unit (TCU) of the vehicle may collect the vehicle operating data and send the data to the remote server for analysis.

### SUMMARY

In one or more illustrative examples, a method for detecting and addressing data spoofing in vehicle signal analysis includes calculating a plurality of trust scores for a plurality of vehicle signals, each of the trust scores measures a likelihood that a respective one of the plurality of vehicle signals is authentic and not spoofed; calculating aggregate trust scores for aggregate signals using the trust scores of the vehicle signals contributing to the aggregate signals, wherein the aggregate signals are created via a transformation performed using one or more of the plurality of the vehicle signals over time; determining whether the trust scores and/or the aggregate trust scores meet a predefined threshold; and applying the vehicle signals and/or the aggregate signals to an analysis model to determine metrics based on the trust scores and/or aggregate trust scores meeting a predefined minimum trust threshold.

In one or more illustrative examples, the vehicle signals and/or the aggregate signals that do not meet the predefined minimum trust threshold are substituted with respective alternative signals and/or alternative aggregate signals.

In one or more illustrative examples, the method further includes determining the alternative signals by one or more of calculating values derived from trusted components of the vehicle signals, and/or utilizing predefined default values corresponding to typical operation parameters.

In one or more illustrative examples, the method further includes computing a global trust score based on the trust scores and/or the aggregate trust scores to assess overall signal reliability.

In one or more illustrative examples, the method further includes adjusting weightings of inputs to the analysis model by applying the trust scores and/or the aggregate trust scores to the analysis model in combination with the vehicle signals and/or the aggregate signals.

In one or more illustrative examples, the method further includes adjusting weightings of inputs to the analysis model by weighing a plurality of outputs of the analysis model using the trust scores and/or the aggregate trust scores to determine the metrics.

In one or more illustrative examples, the analysis model is a machine learning model trained to infer the metrics related to one or more of: usage-based insurance (UBI) evaluations, or maintenance prediction for vehicle components.

In one or more illustrative examples, the trust scores and/or the aggregate trust scores are calculated by comparing data from multiple sources for consistency, including, one or more of cross-referencing global navigation satellite system (GNSS) data with wheel rotation-derived speed, analyzing time-series patterns of sensor data, and/or applying outlier detection methods.

In one or more illustrative examples, a system for detecting and addressing data spoofing in vehicle signal analysis includes a cloud server comprising a memory, one or more hardware processors, and hardware to communicate with vehicles over a communication network, the cloud server configured to receive combined signals from a vehicle, the combined signals including vehicle signals and aggregate signals created via a transformation performed using the vehicle signals over time; determine trust scores for the combined signals, the trust scores being along a scale of how likely a vehicle signal or aggregate signal is real and not spoofed; substitute alternative signals in place of untrusted signals within the combined signals, for each of the untrusted signals that have a corresponding trust score below a predefined threshold level along the scale; apply the combined signals, as substituted, to an analysis model to determine metrics; and send a data select command to the vehicle to inform the vehicle how to combine the vehicle signals and the aggregate signals into the combined signals, the data select command specifying a reconfiguration of the vehicle to exclude the untrusted signals from future combined signals to be sent to the cloud server from the vehicle.

In one or more illustrative examples, the cloud server is further configured to determine the alternative signals by one or more of calculating values derived from trusted components of the vehicle signals, and/or utilizing predefined default values corresponding to typical operation parameters.

In one or more illustrative examples, the cloud server is further configured to compute a global trust score based on the trust scores to assess overall signal reliability.

In one or more illustrative examples, the cloud server is further configured to adjust weightings of inputs to the analysis model by applying the trust scores to the analysis model in combination with the vehicle signals and/or the aggregate signals.

In one or more illustrative examples, the analysis model is a machine learning model trained to infer the metrics related to one or more of: UBI evaluations, or maintenance prediction for vehicle components.

In one or more illustrative examples, the trust scores are calculated by comparing data from multiple sources for consistency, including, one or more of cross-referencing GNSS data with wheel rotation-derived speed, analyzing time-series patterns of sensor data, and/or applying outlier detection methods.

In one or more illustrative examples, a non-transitory computer-readable medium includes instructions for detecting and addressing data spoofing in vehicle signal analysis, that, when executed by one or more hardware processors of a cloud server, cause the cloud server to perform operations including to receive combined signals from a vehicle, the combined signals including vehicle signals and aggregate signals created via a transformation performed using the vehicle signals over time; determine trust scores for the combined signals, the trust scores being along a scale of how likely a vehicle signal or aggregate signal is real and not spoofed; substitute alternative signals in place of untrusted signals within the combined signals, for each of the untrusted signals that have a corresponding trust score below a predefined threshold level along the scale; apply the combined signals, as substituted, to an analysis model to determine metrics; and send a data select command to the vehicle to inform the vehicle how to combine the vehicle signals and the aggregate signals into the combined signals, the data select command specifying a reconfiguration of the vehicle to exclude the untrusted signals from future combined signals to be sent to the cloud server from the vehicle.

In one or more illustrative examples, the non-transitory computer-readable medium further includes instructions that, when executed by the cloud server, cause the cloud server to perform operations including to determine the alternative signals by one or more of calculating values derived from trusted components of the vehicle signals, and/or utilizing predefined default values corresponding to typical operation parameters.

In one or more illustrative examples, the non-transitory computer-readable medium further includes instructions that, when executed by the cloud server, cause the cloud server to perform operations including to compute a global trust score based on the trust scores to assess overall signal reliability.

In one or more illustrative examples, the non-transitory computer-readable medium further includes instructions that, when executed by the cloud server, cause the cloud server to perform operations including to adjust weightings of inputs to the analysis model by applying the trust scores to the analysis model in combination with the vehicle signals and/or the aggregate signals.

In one or more illustrative examples, the analysis model is a machine learning model trained to infer the metrics related to one or more of: UBI evaluations, or maintenance prediction for vehicle components.

In one or more illustrative examples, the trust scores are calculated by comparing data from multiple sources for consistency, including, one or more of cross-referencing GNSS data with wheel rotation-derived speed, analyzing time-series patterns of sensor data, and/or applying outlier detection methods.

### BRIEF DESCRIPTION OF THE DRAWINGS

FIG. 1 illustrates an example system for identifying and addressing data spoofing in the collection and analysis of vehicle data;

FIG. 2 illustrates an example diagram illustrating trust scores relating to the vehicle signals;

FIG. 3 illustrates an example diagram showing a determination of the set of combined signals;

FIG. 4 illustrates an example diagram showing the application of the set of combined signals to the analysis model;

FIG. 5 illustrates an example of an intermittent loss of signal data from the vehicle;

FIG. 6 illustrates an example process for the determination of metrics for the vehicle in view of the trust determinations; and

FIG. 7 illustrates an example computing device for using trust determination to determine vehicle metrics.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Vehicles may rely on low-level signals, to operate. Machine learning analysis models that determine the behavior of the vehicles may rely on the low-level signals and also on higher-level signals generated from the low-level signals. However, alteration of those higher-level signals by an end user may cause the analysis models to produce inaccurate results. Some example alterations may include supplying vehicle data bus signals with fake data, disconnecting location equipment such as global navigation satellite system (GNSS) receivers, hiding or obscuring cameras used to detect eye tracking, and selectively turning off data sharing before performing certain maneuvers.

The analysis model may receive vehicle data as input. If the analysis model utilizes higher-level signals in the form of an aggregation metric/count approach of signal events, the data may additionally or alternatively include incidence of each signal over time. A trust score is determined for each signal and/or aggregated signal that is used by the analysis model. An overall trust score is determined using the individual trust scores. If the trust scores are at least a predefined threshold, those signals are applied to an analysis model and metrics determined by the analysis model are trusted and used.

If the trust scores fail to meet the predefined threshold, alternative signals for applying to the analysis model are used. The alternative signals may be formed using simple rules, as opposed to the actual vehicle signals which may no longer be trusted with the spoofed data. Thus, if spoofed data is detected, the alternative approach may be performed to continue to allow the analysis model to at least partially function. This approach may be applicable to various types of analysis, such as models for use in determining UBI and/or for use in determining vehicle wear or need for servicing.

In some cases, the spoofing or lack of data may be intermittent. This may occur on purpose (e.g., to obscure periods of bad driving), or accidentally (e.g., malfunctioning hardware). To estimate the trust score during this period, data from immediately before and after the missing data period may be used to determine potential for internationally hidden data. Further aspects of the disclosure are discussed in detail herein.

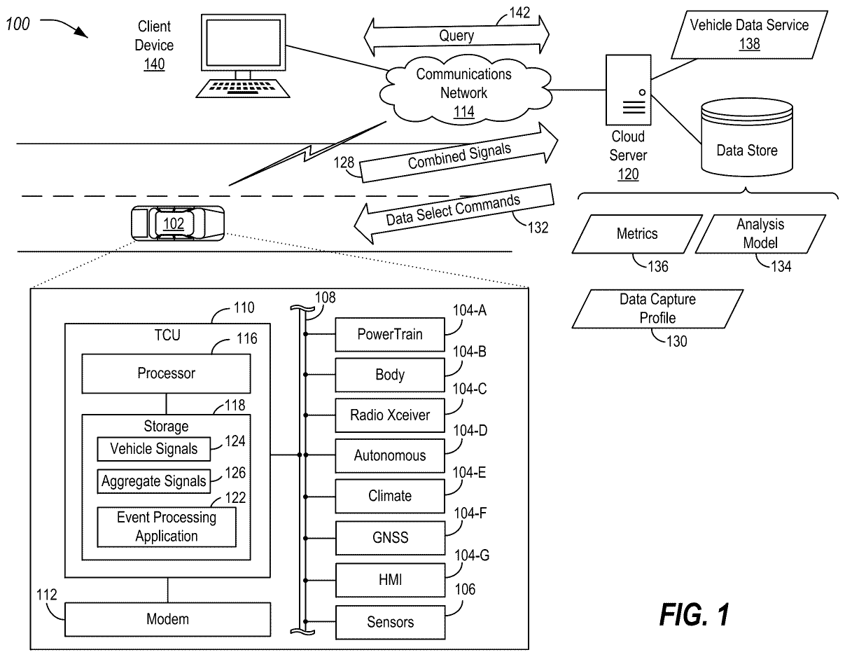

FIG. 1 illustrates an example system 100 for using identifying and addressing data spoofing in the collection and analysis of vehicle data. The system 100 includes one or more vehicles 102, where each vehicle 102 includes a plurality of controllers 104 and sensors 106. Each vehicle 102 also includes one or more vehicle buses 108 for communication between the controller 104, sensors 106, and a TCU 110. The TCU 110 includes or otherwise has access to a modem 112 configured to facilitate communication over a communication network 114. The TCU 110 may include a processor 116 and a storage 118. The TCU 110 may capture vehicle signals 124 and maintain them in the storage 118. The storage 118 may also maintain an event processing application 122 that may generate aggregate signals 126. The event processing application 122 may compile the vehicle signals 124 and/or the aggregate signals 126 into combined signals 128 and may send the combined signals 128 to a cloud server 120. The cloud server 120 may also be configured to execute a vehicle data service 138 that uses one or more analysis models 134 to operate on the combined signals 128 to determine various metrics 136. In some cases, the vehicle data service 138 may send data select commands 132 to inform the TCU 110 how to combine the vehicle signals 124 and the aggregate signals 126 into the combined signals 128. The metrics 136 may also be provided to a client device 140 responsive to client queries 142, in an example, to facilitate quoting insurance rates for the vehicles 102 and/or for scheduling maintenance for the vehicles 102. It should be noted that the system 100 is only an example, and systems 100 with more, fewer, or different components may be used.

The vehicle 102 may be any various types of automobile, crossover utility vehicle (CUV), sport utility vehicle (SUV), truck, recreational vehicle, boat, plane or other mobile machine for transporting people or goods. Such vehicles 102 may be human-driven or autonomous. In many cases, the vehicle 102 may be powered by an engine. As another possibility, the vehicle 102 may be a battery electric vehicle (BEV) powered by one or more electric motors. As a further possibility, the vehicle 102 may be a hybrid electric vehicle (HEV) powered by both an engine and one or more electric motors, such as a series hybrid electric vehicle (SHEV), a parallel hybrid electrical vehicle (PHEV), or a parallel/series hybrid electric vehicle (PSHEV). Alternatively, the vehicle 102 may be an autonomous vehicle (AV). The level of automation may vary between variant levels of driver assistance technology to a fully automatic, driverless vehicle. As the type and configuration of vehicle 102 may vary, the capabilities of the vehicle 102 may correspondingly vary. As some other possibilities, vehicles 102 may have different capabilities with respect to passenger capacity, towing ability and capacity, and storage volume. For title, inventory, and other purposes, vehicles 102 may be associated with unique identifiers, such as vehicle identification numbers (VINs). It should be noted that while automotive vehicles 102 are being used as examples of traffic participants, other types of traffic participants may additionally or alternately be used, such as bicycles, scooters, and pedestrians.

The vehicle 102 may include a plurality of controllers 104 configured to perform and manage various vehicle 102 functions under the power of the vehicle battery and/or drivetrain. As depicted, the example vehicle controllers 104 are represented as discrete controllers 104 (i.e., controllers 104A through 104G). However, the vehicle controllers 104 may share physical hardware, firmware, and/or software, such that the functionality from multiple controllers 104 may be integrated into a single controller 104, and that the functionality of various such controllers 104 may be distributed across a plurality of controllers 104.

As some non-limiting vehicle controller 104 examples: a powertrain controller 104A may be configured to provide control of engine operating components (e.g., idle control components, fuel delivery components, emissions control components, etc.) and for monitoring status of such engine operating components (e.g., status of engine codes); a body controller 104B may be configured to manage various power control functions such as exterior lighting, interior lighting, keyless entry, remote start, and point of access status verification (e.g., closure status of the hood, doors and/or trunk of the vehicle 102); a radio transceiver controller 104C may be configured to communicate with key fobs, mobile devices, or other local vehicle 102 devices; an autonomous controller 104D may be configured to provide commands to control the powertrain, steering, or other aspects of the vehicle 102; a climate control management controller 104E may be configured to provide control of heating and cooling system components (e.g., compressor clutch, blower fan, temperature sensors, etc.); a GNSS controller 104F may be configured to provide vehicle location information; and a human-machine interface (HMI) controller 104G may be configured to receive user input via various buttons or other controls, as well as provide vehicle status information to a driver, such as fuel level information, engine operating temperature information, and current location of the vehicle 102.

The controllers 104 of the vehicle 102 may make use of various sensors 106 in order to receive information with respect to the surroundings of the vehicle 102. In an example, these sensors 106 may include one or more of cameras (e.g., advanced driver-assistance system (ADAS) cameras), ultrasonic sensors, radar systems, and/or lidar systems.

One or more vehicle buses 108 may include various methods of communication available between the vehicle controllers 104, as well as between the TCU 110 and the vehicle controllers 104. As some non-limiting examples, the vehicle bus 108 may include one or more of a vehicle controller area network (CAN), an Ethernet network, and a media-oriented system transfer (MOST) network.

The TCU 110 may include network hardware configured to facilitate communication between the vehicle controllers 104 and with other devices of the system 100. For example, the TCU 110 may include or otherwise access a modem 112 configured to facilitate communication over a communication network 114. The TCU 110 may, accordingly, be configured to communicate over various protocols, such as with the communication network 114 over a network protocol (such as Uu). The TCU 110 may, additionally, be configured to communicate over a broadcast peer-to-peer protocol (such as PC5), to facilitate cellular vehicle-to-everything (C-V2X) communications with devices such as other vehicles 102. It should be noted that these protocols are merely examples, and different peer-to-peer and/or cellular technologies may be used.

The TCU 110 may include various types of computing apparatus in support of performance of the functions of the TCU 110 described herein. In an example, the TCU 110 may include one or more processors 116 configured to execute computer instructions, and a storage 118 medium on which the computer-executable instructions and/or data may be maintained. A computer-readable storage medium (also referred to as a processor-readable medium or storage 118) includes any non-transitory (e.g., tangible) medium that participates in providing data (e.g., instructions) that may be read by a computer (e.g., by the processor(s) 116). In general, the processor 116 receives instructions and/or data, e.g., from the storage 118, etc., to a memory and executes the instructions using the data, thereby performing one or more processes, including one or more of the processes described herein. Computer-executable instructions may be compiled or interpreted from computer programs created using a variety of programming languages and/or technologies, including, without limitation, and either alone or in combination, Java, C, C++, C#, Fortran, Pascal, Visual Basic, Python, Java Script, Perl, etc.

The TCU 110 may be configured to include one or more interfaces from which information of the vehicle 102 may be sent and received. This information can be sensed, recorded, and sent to one or more cloud servers 120. In an example, similar to the TCU 110, the cloud server 120 may also include one or more processors (not shown) configured to execute computer instructions, and a storage medium (not shown) on which the computer-executable instructions and/or data may be maintained.

The event processing application 122 may be an application installed to the TCU 110 for use in performing one or more of the operations of the TCU 110 as discussed in detail herein. In an example, the management of the vehicle signals 124, aggregate signals 126, combined signals 128, etc., may be handled by an event processing application 122 executed by the TCU 110.

The TCU 110 may be configured to facilitate the collection of vehicle signals 124 from the vehicle controllers 104 connected to the one or more vehicle buses 108. These may include, for example, ADAS vehicle signals 124 generated by ADAS functions of the vehicle 102. While only a single vehicle bus 108 is illustrated, it should be noted that in many examples, multiple vehicle buses 108 are included, usually with a subset of the controllers 104 connected to each vehicle bus 108. Accordingly, to access a given controller 104, the TCU 110 may be configured to maintain a mapping of which vehicle buses 108 are connected to which controllers 104, and to access the corresponding vehicle bus 108 for a controller 104 when communication with that particular controller 104 is desired.

As used herein, vehicle signals 124 (e.g., ADAS signals and the like) may refer to various binary, multi-state, integer, float, and/or continuous parameters that may be generated or otherwise raised by the vehicle controller 104 and/or sensors 106. The vehicle signals 124 may include varying unit types, such as time series data of differing frequency and event streams, and/or differing object types such as float, array, matrices, nested data types, etc. As some non-limiting examples, the vehicle signals 124 may include one or more of: latitude, longitude, time, heading angle, speed, throttle position, brake status, steering angle, headlight status, wiper status, external temperature, turn signal status, ambient temperature or other weather conditions, alertness status, hands-off-wheel status, all-wheel drive (AWD) engaged status, front object detection, side object detection status, rear object detection status, etc. Table 1 illustrates an example of vehicle signals 124:

TABLE 1
Example Vehicle Signals

| Vehicle Signal | Value |
|---|---|
| Change in Speed | 0.1 m/s\hat{ }2 |
| Speed | 55 miles per hour (MPH) |

The aggregate signals 126 may refer to running totals or counts or other transformations performed using a plurality the vehicle signals 124 over time as input to generate a single aggregate signal 126 as output. In a simple example, the aggregate signals 126 may include a count of how many times a specific vehicle signal 124 appears in traffic along the vehicle bus 108. In another example, the aggregate signals 126 may include a count of how many times a vehicle signal 124 exceeds (or is below) a predefined threshold value. In yet another example, the aggregate signals 126 may include an analysis of a combination of signals over time as compared to a reference distribution of signals. Table 2 illustrates an example of aggregate signals 126 based on the vehicle signals 124:

TABLE 2
Example Aggregate Signals

| Aggregate Signal | Value |
|---|---|
| Change in Speed, Count of High Changes per Trip | 2 |
| Speed, Over Speed Limit Percent By >20% | 0% |
| Speed & Acceleration Variability | 20% |

The combined signals 128 may refer to a collection of the vehicle signals 124 and the aggregate signals 126. In an example, the vehicle signals 124 and the aggregate signals 126 may be combined into the combined signals 128 based on a data capture profile 130 known or otherwise available to the vehicle 102 and the cloud server 120. The data capture profile 130 may specify which vehicle signals 124 and which aggregate signals 126 should be included in the combined signals 128. In a simple example, the data capture profile 130 may include a listing of the vehicle signals 124 and the aggregate signals 126 to include.

In some examples, the TCU 110 may receive data select commands 132 from the cloud server 120. The data select commands 132 may be used to specify the data capture profile 130 to be used in generating the combined signals 128 from the vehicle signals 124 and the aggregate signals 126.

The analysis model 134 may be any of various machine learning models trained to determine metrics 136 based on the vehicle signals 124 (here the combined signals 128). In an example, an analysis model 134 may be configured to infer metrics 136 related to vehicle 102 based on a training of the analysis model 134 using combined signals 128 from vehicles 102 with known outcomes. In one example, an analysis model 134 may be trained on maintenance data for vehicles 102 based on vehicle signals 124 to allow the analysis model 134 to determine metrics 136 with respect to likely maintenance required by the vehicle 102. In another example, an analysis model 134 may be trained on insurance data for vehicles 102 based on vehicle signals 124 to allow the analysis model 134 to determine metrics 136 with respect to likely incidents that may occur due to how the vehicle 102 is being driven.

The system 100 may further include one or more client devices 140 configured to access the cloud server 120 over the communication network 114. Using the services of the vehicle data service 138 of the cloud server 120, the one or more client devices 140 may be configured to perform client queries 142 for the metrics 136 for various information, e.g., for preparation of insurance quotes for the vehicles 102 and/or for scheduling maintenance of the vehicles 102.

The cloud server 120 utilizes the vehicle data service 138 to generate metrics 136 using the combined signals 128. In an example, the vehicle data service 138 may utilize one or more analysis models 134. For instance, metrics 136 related to insurance may be generated using an insurance analysis model 134, and/or metrics 136 related to maintenance may be generated using a maintenance analysis model 134.

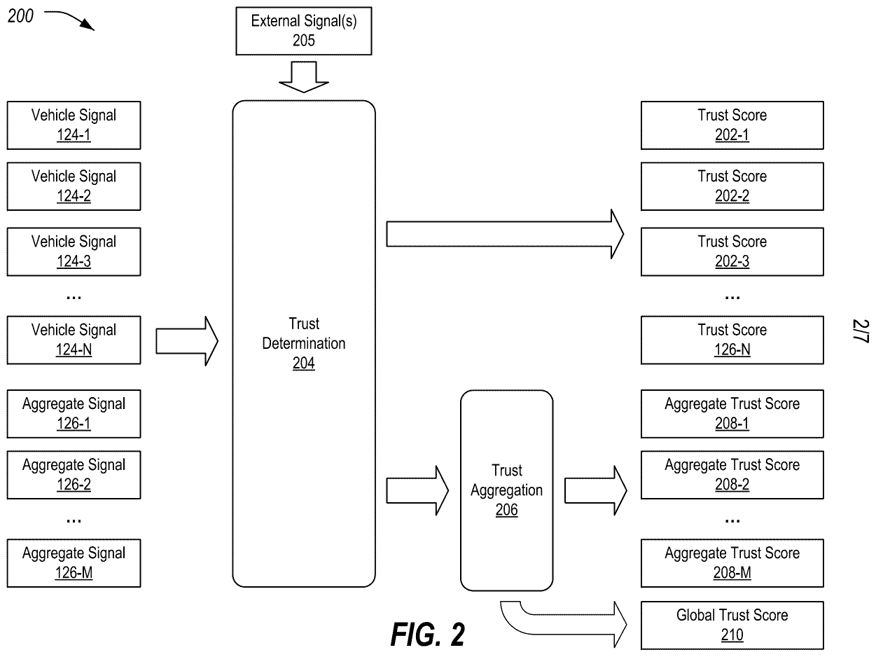

FIG. 2 illustrates an example diagram 200 illustrating trust scores 202 relating to the vehicle signals 124. A trust determination 204 may be performed by the controllers 104 of the vehicle 102 (e.g., the TCU 110, another controller 104, etc.), and/or by the cloud server 120. The trust determination 204 may determine the trust scores 202 for the vehicle signals 124. A trust aggregation 206 may be used to determine aggregate trust scores 208 for the aggregate signals 126. As shown, for vehicle signals 124-1 through 124-N, the trust determination 204 determines corresponding trust scores 202-1 through 202-N. For aggregate signals 126-1 through 126-M, the trust determination 204 and trust aggregation 206 determines corresponding aggregate trust scores 208-1 through 208-M. These trust determinations 204 and trust aggregations 206 may be performed using various approaches.

As used herein, trust scores 202 (and aggregate trust scores 208) refer to a measure along a scale of how likely a vehicle signal 124 (or aggregate signal 126) is real and not spoofed. In some examples, the trust scores 202 (and aggregate trust scores 208) may be represented as values along a scale, such as from 0 to 1. A variety of approaches may be employed to generate the trust scores 202 (and aggregate trust scores 208) for the vehicle signals 124. These approaches may leverage a range of domains and sources to analyze data from sensors 106 and/or vehicle signals 124 for reliability. By combining one or more of these (and/or other) methodologies, the trust scores 202 may be generated for the vehicle signals 124. Table 3 illustrates an example of vehicle signals 124 with associated trust scores 202:

TABLE 3
Example Vehicle Signals with Trust Scores

| | | |
|---|---|---|
| Vehicle Signal | Value | Trust Score |

| | | | |
|---|---|---|---|
| Change in Speed | 0.1 | m/s\hat{ }2 | 0.9 |
| Speed | 55 | MPH | 0.1 |

One approach for determining trust scores 202 involves comparing data across multiple sensors 106 or their signal content. For instance, for the speed vehicle signal 124, data from the wheel rotation rate may be cross-referenced with GNSS-derived speed to evaluate consistency and accuracy. Thus, the trust score 202 for a specific vehicle signal 124 may, in some cases, be determined using other vehicle signals 124 instead of or in addition to being determined using the vehicle signal 124 itself. In another example, for the change in speed vehicle signal 124, the vehicle signal 124 may be compared with commands to slow the vehicle 102 and/or other torque-related commands to ensure coherence in changes in the vehicle signals 124 with the timing of the commands. In yet another example, for an interior camera vehicle signal 124, perception-based approaches may be applied to detect features indicative of static or artificially generated images (e.g., inconsistency with time of day or other ambient conditions, artifacts, unusual movement or lack of movement, etc.).

Additional strategies for the generation of the trust scores 202 may include the use of specialized algorithms or logic to identify potential signal inconsistencies or fraudulent behavior in specific vehicle signals 124 or across all vehicle signals 124. For example, signals-specific algorithms may be used to confirm wheel torque and/or hands on wheel vehicle signals 124. In another example, to account for possible vehicle network spoofing, network monitoring techniques may be leveraged to identify spoofing attempts, such as evaluating network communication patterns or detecting anomalies in data transmissions.

As a further approach, vehicle signals 124 may also be assessed through an inlier/outlier analysis of data sets. This may be conducted either directly on the vehicle 102 or through data sharing with the cloud server 120. Regardless of approach, the outlier detection may look for unusual data or may compare against known spoofing techniques to identify potentially spoofed vehicle signals 124. Outlier behaviors in the vehicle signals 124 may indicate potential tampering or anomalies suggesting a lower trust score 202 and/or warranting investigation (e.g., raising a diagnostic code).

As yet another approach, a time-series analysis of the vehicle signals 124 may be performed. For instance, weight occupancy sensor vehicle signals 124 in conjunction with belt attachment vehicle signals 124 may evaluate coherence before and after key-on/off events, identifying potential discrepancies (e.g., the presence of attachment spoofer devices).

In cases where an aggregate signal 126 is composed of multiple vehicle signals 124 each having its own trust score 202, the trust aggregation 206 may perform a combination of these multiple trust scores 202 to create the aggregate trust scores 208 for the aggregate signals 126. For instance, a harsh driving events per mile average per trip may be formulated as a complex calculation of vehicle signals 124 which may each have a trust score 202 individually. These signal trust scores 202 may be combined into a single aggregate trust score 208. In an example, the trust aggregation 206 may include one or more of averaging the trust scores 202 of the component vehicle signals 124, utilizing a minimum of the trust scores 202 of the component vehicle signals 124 as the aggregate trust scores 208, etc. Table 4 illustrates an example of aggregate signals 126 with associated aggregate trust score 208:

TABLE 4
Example Aggregate Signals with Aggregate Trust Scores

| | | Aggregate Trust |
|---|---|---|
| Aggregate Signal | Value | Score |
| Change in Speed, Count of High | 2 | 0.9 |
| Changes per Trip | | |
| Speed, Over Speed Limit Percent | 0% | 0.1 |
| By >20% | | |
| Speed & Acceleration Variability | 20% | 0.5 |

As shown, the first two aggregate signals 126 (here change in speed and speed) are generated from a single type of vehicle signals 124. Thus, these aggregate signals 126 may be inferred to have the same aggregate trust scores 208 as the trust scores 202 of their respective component signals. However, the third aggregate signals 126 includes signals from the first two vehicle signals 124, so in this simple example, the aggregate trust score 208 is an average of the component vehicle signals 124.

In some examples the trust determination 204 include performing a comparison of vehicle signals 124 on the vehicle buses 108 with external signals 205, which are signals originating from one or more sources apart from the vehicle buses 108 or even from the vehicle 102 itself. This use of external signals 205 may be useful as a source of ground truth.

In another example, image recognition techniques may be used as a source of ground truth. For instance, an image recognition model may be used to confirm that camera images captured by the sensors 106 of the vehicle 102 are consistent with the GNSS location of the vehicle 102 as reported via the messaging on the vehicle bus 108.

In some cases, a global trust score 210 may be determined by the trust aggregation 206. This may be done, for example, to determine an overall baseline trust score 202 across all vehicle signals 124. This global trust score 210 may be used to determine a likelihood of an overall spoofing of all vehicle signals 124 (e.g., due to a man-in-the-middle attack with a plug-in on-board diagnostic (OBD) port device).

In some cases, the determination of the global trust score 210 may account for aspects such as external signals 205 that are difficult to spoof, such as GNSS, accelerometer signals from a phone, etc. As some other possibilities, the global trust score 210 may be determined by the trust aggregation 206 by a low-level signal data analysis to detect pattern or outliers of data indicating a globally low trust score 202 across all vehicle signals 124 (e.g., everything is believed to be spoofed). Other possible approaches for the determination of the global trust score 210 may include fingerprinting of messages over the vehicle buses 108, spoofing signal analysis over the vehicle bus 108, etc.

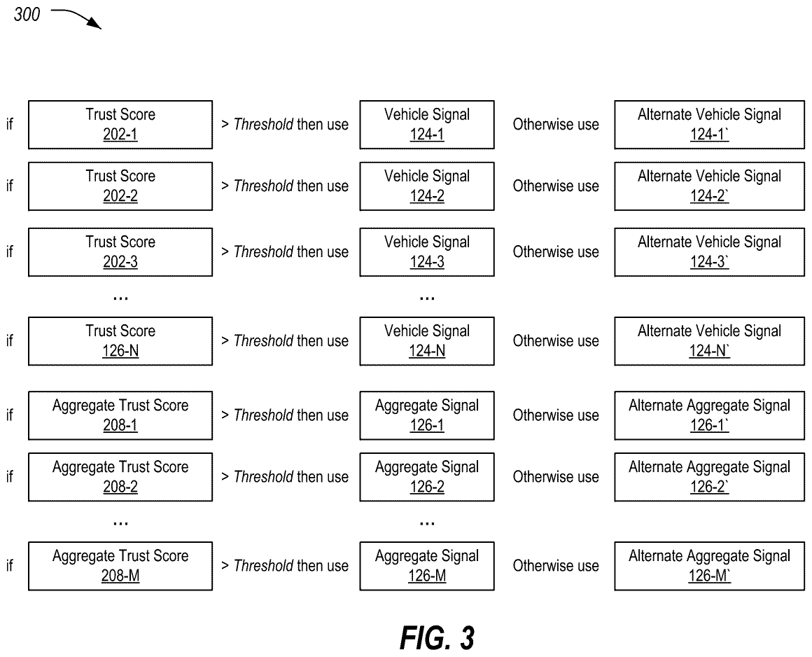

FIG. 3 illustrates an example diagram 300 showing a determination of the set of combined signals 128. As shown in the diagram 300, for each of the vehicle signals 124, if the trust score 202 is greater than a predefined threshold, then that vehicle signal 124 is included in the combined signals 128. Otherwise, an alternate vehicle signal 124 is included in the combined signals 128. Similarly, for each of the aggregate signals 126, if the aggregate trust scores 208 is greater than the predefined threshold (or a different aggregate threshold), then that aggregate signal 126 is included in the combined signals 128. Otherwise, an alternate aggregate signal 126′ is included in the combined signals 128. The set of combined signals 128 determined in this way, may then be applied as an input to the analysis model 134. The analysis model 134 may then determine metrics 136 based on the combined signals 128.

Regarding the computation of the alternate vehicle signals 124′ and the alternate aggregate signals 126′, various approaches may be used to determine the alternate vehicle signals 124′ and the alternate aggregate signals 126.

For example, the alternate vehicle signals 124′ may be determined by applying rules-based approaches or preconfigured default values. For instance, if a GNSS signal is deemed untrustworthy, an alternate vehicle signal 124 for location could be derived using data from accelerometers and a last known trusted position. Similarly, if speed signals are untrustworthy, wheel rotation rate or other drivetrain metrics could be used as an alternate signal source.

In another example, the alternate aggregate signals 126′ may be determined by recalculating aggregate values using only trusted components or predefined approximations. For instance, if a count of harsh braking events per trip is part of an aggregate signal 126 and certain braking signals are untrustworthy, alternate aggregate signals 126 could be computed using a subset of reliable speed and deceleration metrics. In cases where sufficient data is unavailable, statistical estimates or historical averages may be applied as a fallback to maintain system functionality.

In yet another example, a fixed default value may be used as the aggregate signals 126 in cases where the aggregate signals 126 are untrusted. For example, if a belt signal is deemed unreliable, a fixed increased value as compared to a non-spoofed driver may be used. In some examples, if a spoofing or low trust score 202 is determined, the vehicle 102 may alert the driver to the issue detected (e.g. your belt fake device is costing you $X dollars more per month, please remove it).

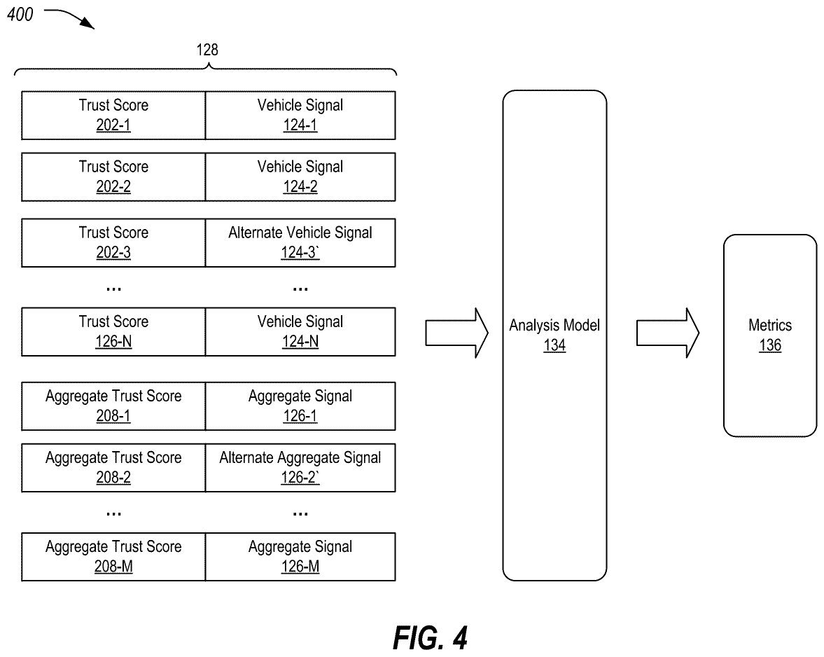

FIG. 4 illustrates an example diagram 400 showing the application of the set of combined signals 128 to the analysis model 134. As shown, the combined signals 128 includes both vehicle signals 124 and aggregate signals 126, but in other examples the combined signals 128 may include only aggregate signals 126 or only vehicle signals 124. Also, the combined signals 128 includes some alternate vehicle signals 124′ and alternate aggregate signals 126′, e.g., based on the determination as shown in FIG. 3, but this is also just an example. In some cases, no alternate vehicle signals 124′ or alternate aggregate signals 126′ may be used, or in some cases all alternate vehicle signals 124′ and all alternate aggregate signals 126′ may be used.

It should also be noted that in the illustrated example, the trust scores 202 and aggregate trust scores 208 are applied to the analysis model 134 as input. This allows the analysis model 134 to consider the reliability of the vehicle signals 124 and/or aggregate signals 126 when inferring the metrics 136. In such an example, the analysis model 134 maty be required to be trained on input data that also includes trust scoring. In other examples, the global trust scores 210 may also be provided to the analysis model 134 as input.

In still other examples, only the signals but not also the trust scores 202 and/or aggregate trust scores 208 may be provided. In such a case the analysis models 134 may rely more on the alternate vehicle signals 124′ and/or alternate aggregate signals 126′ to address the potential for spoofing.

In some examples, the analysis models 134 may provide a plurality of outputs for different aspects of a final metric 136 score. In such an example, the trust scores 202 may be used to weigh each of the plurality of outputs for the different aspects when constructing the final metric 136.

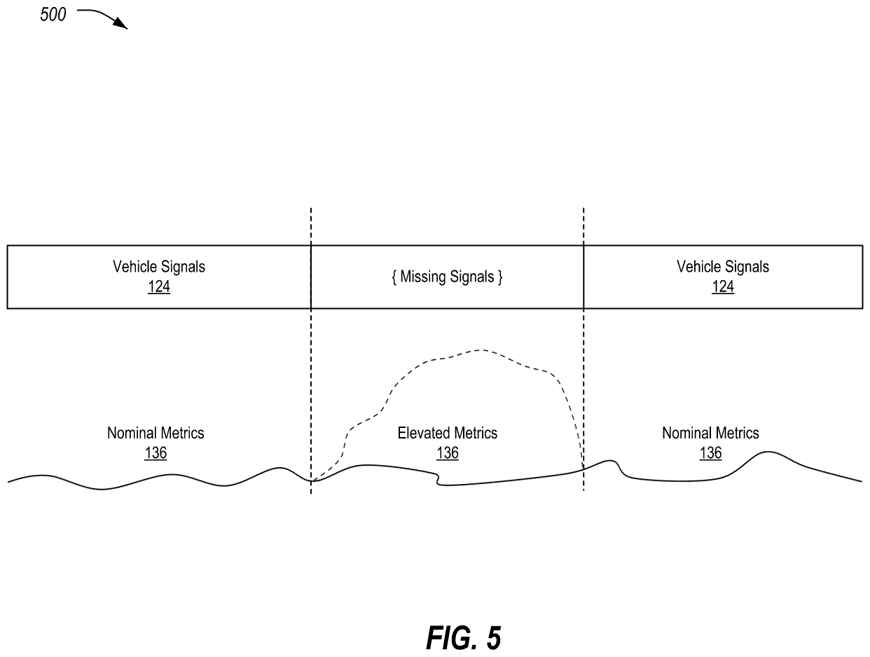

FIG. 5 illustrates an example 500 of an intermittent loss of signal data from the vehicle 102. As shown, vehicle signals 124 are available for a first time period, then are missing for a second time period, and then are available again for a third time period.

Using the trust scores 202, the cloud server 120 may make determinations about the validity of the vehicle signals 124. For example, aspects of the presence or absence of signals in the vehicle signals 124 may be used to determine whether the vehicle signals 124 are likely valid or invalid. If some or all data elements are missing from the vehicle signals 124, then it can be inferred that there may be a spoofing event occurring.

The trust scores 202 may be used to predict whether a modem 112 or other loss of communication is related to a spoofing attempt or to a technical failure of the communication network 114. If the disconnection occurs intermittently (e.g., to hide an hour of track racing or a harsh driving events), the trust scores 202 before and after the event may be used to predict likelihood of the occurrence during the time of no data. For example, the total mileage usage and/or outage time may be used to infer predict average speed, which may or may not additionally be compared to local driving region speed limits before and after the outage period. In another example, outlier detection, machine learning (ML), and/or statistical data analysis of the time and/or duration of the loss of communication may be used.

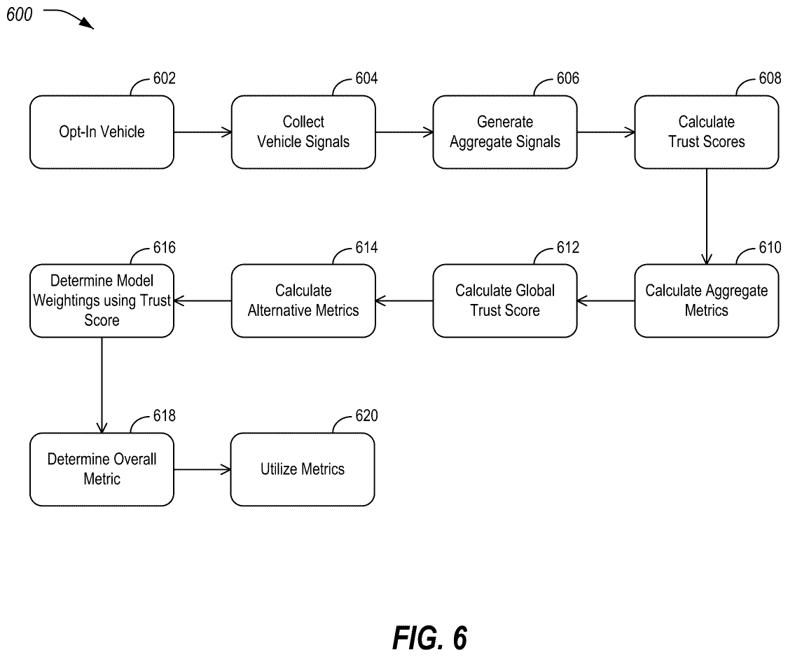

FIG. 6 illustrates an example process 600 for the determination of metrics 136 for the vehicle 102 in view of the trust determinations 204. In an example, the process 600 may be performed by the cloud server 120 in communication over the communication network 114 with the vehicle 102.

At operation 602, the system 100 opts in the vehicle 102 for use of the metrics 136. This may include obtaining consent from the owner or operator of the vehicle 102 to collect and process vehicle signals 124. This may involve providing a user interface on the client device 140 or directly in the vehicle 102 to present terms of service and obtain user approval for participation in the system 100.

At operation 604, the system 100 collects vehicle signals 124. In an example, the TCU 110 may gather vehicle signals 124 from the various controllers 104 and sensors 106 via the vehicle buses 108. The collected data may include time-series measurements such as speed, location, and other operational parameters generated by the vehicle 102 during operation.

At operation 606, the system 100 generates aggregate signals 126. Using the collected vehicle signals 124, the event processing application 122 may calculate aggregates, such as counts or averages, to provide higher-level insights. For example, the event processing application 122 may compute the frequency of harsh braking events or the percentage of time spent exceeding speed limits. The specific aggregations to perform may be defined by the data capture profile 130 sent to the vehicle 102.

At operation 608, the system 100 calculates trust scores 202 for the vehicle signals 124. In an example, the TCU 110 and/or the cloud server 120 evaluates the reliability of each vehicle signals 124 using approaches such as cross-referencing data from multiple sources, time-series analysis, and/or outlier detection techniques.

At operation 610, the system 100 calculates aggregate trust scores 208 for the aggregate signals 126. In an example, the TCU 110 and/or the cloud server 120 evaluates the reliability of each of the aggregate signals 126. The trust scores 202 for individual vehicle signals 124 may be combined using various trust aggregation 206 methods, such as averaging or applying the minimum score, to determine the reliability of aggregate signals 126.

At operation 612, the system 100 calculates a global trust score 210. In an example, the TCU 110 and/or the cloud server 120 evaluates the overall reliability across the vehicle signals 124 and/or the aggregate signals 126 to produce an overall assessment of data reliability. The global trust score 210 may also account for external data sources as a reference.

At operation 614, the system 100 calculates alternative vehicle signals 124′ and/or alternative aggregate signals 126′. For vehicle signals 124 and/or aggregate signals 126 with low trust scores 202, the TCU 110 and/or the cloud server 120 may generate alternative values using rules-based approaches, statistical estimates, or fallback defaults to maintain system 100 functionality.

At operation 616, the system 100 determines model weightings using the trust scores 202 and aggregate trust scores 208. In an example, based on the calculated trust scores 202 and/or aggregate trust scores 208, the cloud server 120 adjusts the weightings of the analysis model 134 to prioritize more reliable vehicle signals 124 and/or aggregate signals 126.

At operation 618, the system 100 determines the metrics 136 using the analysis models 134. In an example, the cloud server 120 may utilize a UBI analysis model 134 to predict UBI metrics 136 for determining of UBI. In another example, the cloud server 120 may utilize a maintenance analysis model 134 to predict maintenance metrics 136 for determining when to perform maintenance on the vehicle 102.

At operation 620, the system 100 utilizes the metrics 136. In an example, the metrics 136 may be queried by a client device 140 using client queries 142, where the results of the client queries 142 are used for servicing the vehicle 102. In another example, the metrics 136 may be queried by a client device 140 using client queries 142, where the results of the client queries 142 are used for determining rates for the vehicle 102. In yet another example, the cloud server 120 transmits a data select command 132 to the TCU 110, to specify a reconfiguration of the TCU 110 to exclude the vehicle signals 124 that may be of low trust (e.g., per the trust scores 202 and/or aggregate trust scores 208). After operation 620, the process 600 ends.

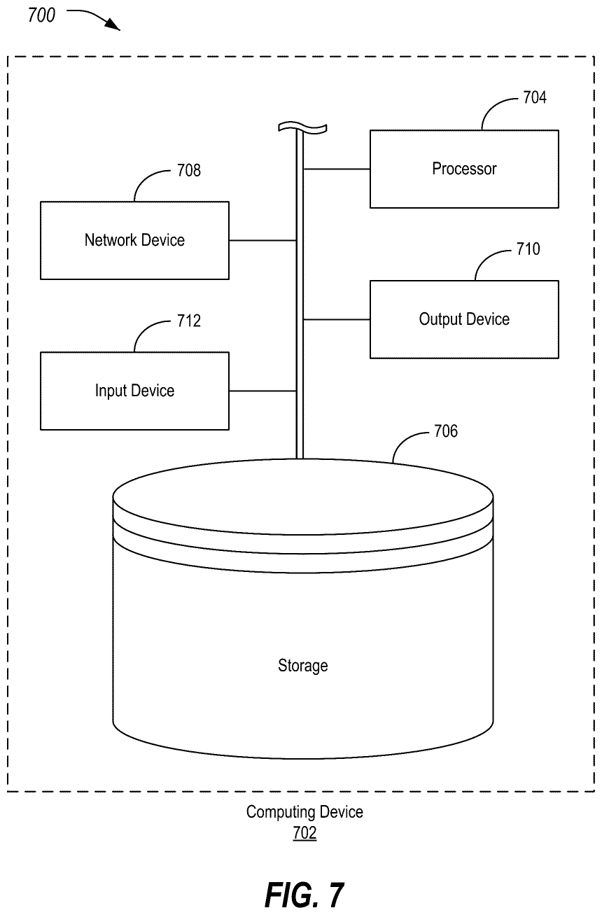

FIG. 7 illustrates an example computing device 702 for using trust determination 204 to determine vehicle metrics 136. Referring to FIG. 7, and with reference to FIGS. 1-6, the vehicle 102, controllers 104, sensors 106, TCU 110, and cloud server 120 may be examples of such computing devices 702. Computing devices 702 generally include computer-executable instructions, such as those of the vehicle data service 138 and the event processing application 122, where the instructions may be executable by one or more computing devices 702. Computer-executable instructions may be compiled or interpreted from computer programs created using a variety of programming languages and/or technologies, including, without limitation, and either alone or in combination, Java™, C, C++, C#, Visual Basic, JavaScript, Python, JavaScript, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data, such as vehicle signals 124, aggregate signals 126, combined signals 128, data capture profiles 130, data select commands 132, analysis models 134, metrics 136, the vehicle data service 138, etc., may be stored and transmitted using a variety of computer-readable media.

As shown, the computing device 702 may include a processor 704 that is operatively connected to a storage 706, a network device 708, an output device 710, and an input device 712. It should be noted that this is merely an example, and computing devices 702 with more, fewer, or different components may be used.

The processor 704 may include one or more integrated circuits that implement the functionality of a central processing unit (CPU) and/or graphics processing unit (GPU). In some examples, the processors 704 are a system on a chip (SoC) that integrates the functionality of the CPU and GPU. The SoC may optionally include other components such as, for example, the storage 706 and the network device 708 into a single integrated device. In other examples, the CPU and GPU are connected to each other via a peripheral connection device such as Peripheral Component Interconnect (PCI) express or another suitable peripheral data connection. In one example, the CPU is a commercially available central processing device that implements an instruction set such as one of the x86, ARM, Power, or Microprocessor without Interlocked Pipeline Stages (MIPS) instruction set families.

Regardless of the specifics, during operation the processor 704 executes stored program instructions that are retrieved from the storage 706. The stored program instructions, accordingly, include software that controls the operation of the processors 704 to perform the operations described herein. The storage 706 may include both non-volatile memory and volatile memory devices. The non-volatile memory includes solid-state memories, such as Not AND (NAND) flash memory, magnetic and optical storage media, or any other suitable data storage device that retains data when the system is deactivated or loses electrical power. The volatile memory includes static and dynamic random access memory (RAM) that stores program instructions and data during operation of the system 100.

The GPU may include hardware and software for display of at least two-dimensional (2D) and optionally three-dimensional (3D) graphics to the output device 710. The output device 710 may include a graphical or visual display device, such as an electronic display screen, projector, printer, or any other suitable device that reproduces a graphical display. As another example, the output device 710 may include an audio device, such as a loudspeaker or headphone. As yet a further example, the output device 710 may include a tactile device, such as a mechanically raiseable device that may, in an example, be configured to display braille or another physical output that may be touched to provide information to a user.

The input device 712 may include any of various devices that enable the computing device 702 to receive control input from users. Examples of suitable input devices 712 that receive human interface inputs may include keyboards, mice, trackballs, touchscreens, microphones, graphics tablets, and the like.

The network devices 708 may each include any of various devices that enable the described components to send and/or receive data from external devices over networks. Examples of suitable network devices 708 include an Ethernet interface, a Wi-Fi transceiver, a cellular transceiver, or a BLUETOOTH or BLUETOOTH Low Energy (BLE) transceiver, or other network adapter or peripheral interconnection device that receives data from another computer or external data storage device, which can be useful for receiving large sets of data in an efficient manner.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments may occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A method for detecting and addressing data spoofing in vehicle signal analysis, comprising:
calculating a plurality of trust scores for a plurality of vehicle signals, each of the trust scores measures a likelihood that a respective one of the plurality of vehicle signals is authentic and not spoofed;
calculating aggregate trust scores for aggregate signals using the trust scores of the vehicle signals contributing to the aggregate signals, wherein the aggregate signals are created via a transformation performed using one or more of the plurality of the vehicle signals over time;
determining whether the trust scores and/or the aggregate trust scores meet a predefined threshold; and
applying the vehicle signals and/or the aggregate signals to an analysis model to determine metrics based on the trust scores and/or aggregate trust scores meeting a predefined minimum trust threshold.

2. The method of claim 1, wherein the vehicle signals and/or the aggregate signals that do not meet the predefined minimum trust threshold are substituted with respective alternative signals and/or alternative aggregate signals.

3. The method of claim 2, further comprising determining the alternative signals by one or more of calculating values derived from trusted components of the vehicle signals, and/or utilizing predefined default values corresponding to typical operation parameters.

4. The method of claim 1, further comprising computing a global trust score based on the trust scores and/or the aggregate trust scores to assess overall signal reliability.

5. The method of claim 1, further comprising adjusting weightings of inputs to the analysis model by applying the trust scores and/or the aggregate trust scores to the analysis model in combination with the vehicle signals and/or the aggregate signals.

6. The method of claim 1, further comprising adjusting weightings of inputs to the analysis model by weighing a plurality of outputs of the analysis model using the trust scores and/or the aggregate trust scores to determine the metrics.

7. The method of claim 1, wherein the analysis model is a machine learning model trained to infer the metrics related to one or more of: usage-based insurance (UBI) evaluations, or maintenance prediction for vehicle components.

8. The method of claim 1, wherein the trust scores and/or the aggregate trust scores are calculated by comparing data from multiple sources for consistency, including, one or more of cross-referencing global navigation satellite system (GNSS) data with wheel rotation-derived speed, analyzing time-series patterns of sensor data, and/or applying outlier detection methods.

9. A system for detecting and addressing data spoofing in vehicle signal analysis, comprising:
a cloud server comprising a memory, one or more hardware processors, and hardware to communicate with vehicles over a communication network, the cloud server configured to
receive combined signals from a vehicle, the combined signals including vehicle signals and aggregate signals created via a transformation performed using the vehicle signals over time;
determine trust scores for the combined signals, the trust scores being along a scale of how likely a vehicle signal or aggregate signal is real and not spoofed;
substitute alternative signals in place of untrusted signals within the combined signals, for each of the untrusted signals that have a corresponding trust score below a predefined threshold level along the scale;
apply the combined signals, as substituted, to an analysis model to determine metrics; and
send a data select command to the vehicle to inform the vehicle how to combine the vehicle signals and the aggregate signals into the combined signals, the data select command specifying a reconfiguration of the vehicle to exclude the untrusted signals from future combined signals to be sent to the cloud server from the vehicle.

10. The system of claim 9, wherein the cloud server is further configured to determine the alternative signals by one or more of calculating values derived from trusted components of the vehicle signals, and/or utilizing predefined default values corresponding to typical operation parameters.

11. The system of claim 9, wherein the cloud server is further configured to compute a global trust score based on the trust scores to assess overall signal reliability.

12. The system of claim 9, wherein the cloud server is further configured to adjust weightings of inputs to the analysis model by applying the trust scores to the analysis model in combination with the vehicle signals and/or the aggregate signals.

13. The system of claim 9, wherein the analysis model is a machine learning model trained to infer the metrics related to one or more of: UBI evaluations, or maintenance prediction for vehicle components.

14. The system of claim 9, wherein the trust scores are calculated by comparing data from multiple sources for consistency, including, one or more of cross-referencing GNSS data with wheel rotation-derived speed, analyzing time-series patterns of sensor data, and/or applying outlier detection methods.

15. A non-transitory computer-readable medium comprising instructions for detecting and addressing data spoofing in vehicle signal analysis, that, when executed by one or more hardware processors of a cloud server, cause the cloud server to perform operations including to:
receive combined signals from a vehicle, the combined signals including vehicle signals and aggregate signals created via a transformation performed using the vehicle signals over time;
determine trust scores for the combined signals, the trust scores being along a scale of how likely a vehicle signal or aggregate signal is real and not spoofed;
substitute alternative signals in place of untrusted signals within the combined signals, for each of the untrusted signals that have a corresponding trust score below a predefined threshold level along the scale;
apply the combined signals, as substituted, to an analysis model to determine metrics; and
send a data select command to the vehicle to inform the vehicle how to combine the vehicle signals and the aggregate signals into the combined signals, the data select command specifying a reconfiguration of the vehicle to exclude the untrusted signals from future combined signals to be sent to the cloud server from the vehicle.

16. The non-transitory computer-readable medium of claim 15, further comprising instructions that, when executed by the cloud server, cause the cloud server to perform operations including to determine the alternative signals by one or more of calculating values derived from trusted components of the vehicle signals, and/or utilizing predefined default values corresponding to typical operation parameters.

17. The non-transitory computer-readable medium of claim 15, further comprising instructions that, when executed by the cloud server, cause the cloud server to perform operations including to compute a global trust score based on the trust scores to assess overall signal reliability.

18. The non-transitory computer-readable medium of claim 15, further comprising instructions that, when executed by the cloud server, cause the cloud server to perform operations including adjust weightings of inputs to the analysis model by applying the trust scores to the analysis model in combination with the vehicle signals and/or the aggregate signals.

19. The non-transitory computer-readable medium of claim 15, wherein the analysis model is a machine learning model trained to infer the metrics related to one or more of: UBI evaluations, or maintenance prediction for vehicle components.

20. The non-transitory computer-readable medium of claim 15, wherein the trust scores are calculated by comparing data from multiple sources for consistency, including, one or more of cross-referencing GNSS data with wheel rotation-derived speed, analyzing time-series patterns of sensor data, and/or applying outlier detection methods.
